(19) United States
(12) Patent Application Publication
(10) Pub. No.: US 2025/0033595 A1
(43) Pub. Date: Jan. 30, 2025

(54) BELT TIGHTENER HAVING A SPUR GEAR

(71) Applicants: ZF AUTOMOTIVE GERMANY GMBH, Alfdorf (DE); ZF FRIEDRICHSHAFEN AG, Friedrichshafen (DE)

(72) Inventors: Michael LOHMEIER, Schwabisch Gm¿nd (DE); Wolfgang HOLBEIN, Alfdorf (DE); Johannes KÖNIG, Friedichshafen (DE)

(21) Appl. No.: 18/716,276

(22) PCT Filed: Dec. 5, 2022
(86) PCT No.: PCT/EP2022/084377

§ 371 Date: Jun. 5, 2024

(30) Foreign Application Priority Data
Dec. 7, 2021 (DE) 10 2021 132 186.7

(51) Int. Cl. B60R 22/46

(52) U.S. Cl. CPC B60R 22/46; B60R 2022/4666; B60R 2022/469

(57) ABSTRACT

A belt tensioner for a seatbelt system comprising a spur gearing (18). The spur gearing (18) comprises at least one motor gearwheel (24) and at least a first stepped wheel (26) and a second stepped wheel (28). The motor gearwheel (24) forms a first gear stage (34) with the first stepped wheel (26), and the first stepped wheel (26) forms a second gear stage (36) with the second stepped wheel (28). The motor gearwheel (24) and each of the stepped wheels (24, 26) include helical teeth, and the helix angle of the helical teeth of the second gear stage (36) is determined depending on the helix angle of the first gear stage (34). The overlap ratio of at least one helical toothing is not integer.

### TECHNICAL FIELD

The invention relates to a belt tensioner for a seatbelt system comprising a spur gearing.

### BACKGROUND

A belt tensioner serves to reduce, in a case of restraint, certain influences which have a negative effect on the restraint of a vehicle occupant, before the forward displacement of the vehicle occupant and, if necessary, the use of a load-limiting device begin. Those influences include, for example, the so-called film reel effect and the belt slack. The film reel effect relates to webbing wound loosely onto a belt reel. In the case of the belt slack, the webbing is only loosely fitted to the vehicle occupant. The belt tensioner reduces the belt slack and the film reel effect within a split second by winding the webbing onto a belt reel of a belt retractor, for example, and thus tensions the webbing. Consequently, the vehicle occupant can take part in the vehicle deceleration at an early stage. Moreover, the conditions for the subsequent use of a load-limiting device are improved.

For this purpose, use can be made of belt tensioners which are driven by means of an electric motor, in particular reversible belt tensioners. “Reversible” in this context means that, after tensioning by the electric motor, the gearing is disconnected from the belt reel again and, thus, the “normal” retractor functions can be realized again. The gearing can be driven in two directions of rotation. As a rule, a clutch is used for transmitting the torque from the gearing to the belt reel. For tensioning, a high torque must be provided at a high speed so that the belt can be tensioned with sufficient force and sufficiently quickly. To this end, the high speed of the electric motor is reduced by a gearing so that relatively low speeds—in relation to the motor speed—and high torques—in relation to the motor torque—are applied to the belt reel.

For transmitting the torque of the electric motor, various types of gearings are known from prior art. For example, a spur gearing can be used in which plural spur wheels can be switched successively on parallel shafts. Spur gearings offer the advantage that different transmission ratios and plural gear stages can be realized in a relatively simple manner.

In addition to the requirements in terms of the transmission of the torque, also reliability, smooth running and the costs of the spur gearing are important when designing the belt tensioner, however. It is basically known to use a combination of straight gears and helical gears in spur gearings. Helical gears in particular feature lower noise development in operation and, thus, smoother running, but the manufacture thereof is considerably more cost-intensive than that of straight gears.

Gearwheels for spur gearings can be made either of metal, such as of steel or brass, or of plastic. Gearwheels made of plastic also improve the smooth running, but can resist only lower mechanical loads in the long run, however.

For reasons of cost, therefore in spur gearings for belt tensioners cost-intensive helical gears made of metal are typically used in a first gear stage only to be able to handle the torque transmitted from the electric motor by means of a motor pinion while simultaneously improving the smooth running. The following gearwheels are usually designed of plastic and with straight teeth to find a compromise between smooth running, wear resistance and costs. However, such a design does not offer a satisfactory solution for all applications.

### SUMMARY

It is the object of the invention to provide a belt tensioner that allows for very smooth running and, in particular, can be manufactured at low cost.

The object of the invention is achieved by a belt tensioner for a seatbelt system comprising a spur gearing. The spur gearing comprises at least one motor gearwheel and at least a first stepped wheel and a second stepped wheel. The motor gearwheel forms a first gear stage with the first stepped wheel, and the first stepped wheel forms a second gear stage with the second stepped wheel. The motor gearwheel and each of the stepped wheels have helical teeth, and the helix angle of the helical teeth of the second gear stage is defined depending on the helix angle of the first gear stage. The overlap ratio of at least one of the helical teeth is not integer.

The belt tensioner according to the invention specifically is a reversible belt tensioner.

As, according to the invention, each of the stepped wheels features helical teeth, the spur gearing and, thus, the belt tensioner according to the invention excel by excellent smooth running.

The term “helix angle of a gear stage” means here and below that the gearwheels involved in the respective gear stage, i.e., the motor gearwheel and/or involved stepped wheels, have helical teeth with the corresponding helix angle.

The engine gearwheel is the gearwheel which is driven by means of an output shaft of a drive, preferably by means of an output shaft of an electric motor.

In known spur gearings with helical teeth, the overlap ratio is selected to be integer to ensure uniform torque transmission, the overlap ratio being dependent on the tooth width and the helix angle of the helical teeth. This results in large helix angles of 30° or more, causing high axial loads to act on the gearwheels and existing bearing points of the gearwheels which axial loads have to be compensated by expensive constructional designs, such as by stiffened sections.

It was found that a particularly long-lasting spur gearing with very smooth running can be realized by adapting the helix angle of the second gear stage depending on the helix angle of the first gear stage and, at the same time, by the use of at least one helical toothing with non-integer overlap ratio, while simultaneously considerably smaller helix angles can be applied.

In other words, the overlap ratio is no longer bound to integer multiples, but can be selected with respect to a desired load distribution or distribution of the occurring mechanical loads within the spur gearing.

For example, the helix angle of at least one gear stage, specifically of the second and each higher gear stage, is less than 10°.

In a variant, the helix angle of each gear stage is less than 10°.

By the use of such small helix angles, the axial forces acting on the respective gear stage can be reduced so that the design expenditure and, thus, the costs of the spur gearing can be minimized without negatively affecting the long-life cycle and the smooth running of the belt tensioner.

The overlap ratio of at least one helical toothing, preferably of each helical toothing or each helical toothing higher than the second gear stage, is specifically smaller than 1.

Each stepped wheel is aligned in particular by means of a shaft extending axially through the stepped wheel which is supported at a bearing point dedicated to the respective shaft on a housing of the belt tensioner. By adjusting the helix angles of the first and second gear stages in combination with non-integer helical teeth, the forces acting on the dedicated bearing points can be purposefully configured so that the design expenditure when designing the bearing points and the costs of manufacture of the belt tensioner can be kept low.

In a variant, with an increasing gear stage, a decreasing axial force acts on the bearing points dedicated to the respective stepped wheels, or a substantially equal axial force acts on all bearing points dedicated to the respective stepped wheels. In this way, a particularly uniform load distribution is enabled within the belt tensioner, allowing a particularly smooth running to be achieved. With an axial force decreasing with increasing gear stages, the bearing points can be further designed to be simpler and more cost-effective with increasing gear stages, without the long-life cycle and the smooth running of the spur gearing being negatively affected. Thus, the constructional effort and the costs of the belt tensioner can be minimized.

For further reducing the manufacturing costs of the belt tensioner according to the invention, the shaft of at least one stepped wheel, and in particular the shafts of all stepped wheels, can be supported at a first axial end of the shaft by means of an injection-molded connection on the housing. This additionally ensures stable support and exact alignment of the stepped wheel associated with the respective shaft.

The shafts can be configured in particular in the form of a bearing pin having a collar-shaped projection. The collar-shaped projection in this case particularly acts as a bearing point for the respective stepped wheel to ensure exact alignment of the stepped wheel.

In this variant, the collar-shaped projection can be supported on the housing by means of an injection-molded connection to ensure reliable fixation of the shaft.

For increasing the wear resistance and the long-life cycle of the belt tensioner, the shafts can be made of metal, specifically of steel or brass. In particular, when a bearing pin having collar-shaped projections is used, the friction between the collar-shaped projection and the dedicated stepped wheel can be reduced additionally by selecting a suitable metal.

The shaft of at least one stepped wheel, in particular the shafts of all stepped wheels, can further be supported at a second axial end of the shaft on a cover of the belt tensioner. This safeguards reliable alignment of the shaft, even if mechanical loads occur when the belt tensioner is operated, so that the stepped wheel associated with the respective shaft is precisely aligned.

In a variant, the shaft is arranged in a dedicated mount of the cover which encloses the shaft at its second axial end preferably at least partly and, in this way, prevents or at least partly prevents radial movements of the shaft.

The support of the second axial end of the shaft on the cover helps ensure a defined startup of the respective stepped wheel, even if the direction of the rotary motion of the respective stepped wheel is inverted.

In a variant, the helix angle of the helical teeth of the first gear stage is defined according to the following formula (1):

$${β}_{1} = arcsin ( \frac{{F}_{AxM} * {d}_{w 1.1}}{{T}_{M}} * \frac{1}{b} ) ,$$

wherein β1 denotes the helix angle of the first gear stage, FAxM denotes the axial force acting on the motor gearwheel, dw1.1 denotes the pitch circle diameter of the motor gearwheel in the first gear stage, TM denotes the drive torque acting on the motor gearwheel and 1/b denotes a predetermined fraction of the axial force FAxM acting on the motor gearwheel which is intended to act on the bearing point of the first gear stage.

By selecting a suitable factor 1/b the loads which the bearing point of the first gear stage has to withstand and, thus, the complexity of the design of the corresponding bearing point can be specified so as to ensure a sufficient long-life cycle of the belt tensioner.

The factor 1/b can be, for example, in the range from 0.4 to 0.8, specifically in the range from 0.5 to 0.75.

In other words, b is, for example, in the range from 1.25 to 2.5, specifically in the range from 1.33 to 2.0.

Preferably, the helix angle of the second gear stage is determined according to the following formula (2):

$${β}_{2} = arcsin ( \frac{{d}_{w 2.1}}{{d}_{w 1.2}} * \frac{1}{b} * sin ( {β}_{1} ) ) ,$$

wherein β2 denotes the helix angle of the second gear stage, dw2.1 denotes the pitch circle diameter of the first stepped wheel in the second gear stage, and dw1.2 denotes the pitch circle diameter of the first stepped wheel in the first gear stage.

In other words, according to the invention, the value of the helix angle of the first gear stage, as it can be established according to formula (1), is preferably provided to be integrated in the calculation of the helix angle of the second gear stage. Hence, the factor 1/b selected when designing the first gear stage is also integrated in the design of the helix angle of the second gear stage.

In a further variant, the spur gearing comprises more than two stepped wheels and more than two gear stages, the helix angle of the helical teeth of the second or higher gear stage being determined depending on the helix angle of the respective upstream gear stage.

In other words, the existing helical teeth are adjusted, wherein the size of the respective helical angles is determined iteratively with consideration of the helical angle of the respective preceding gear stage.

Preferably, the helix angle of the second or higher gear stage is determined in each case according to the following formula (3):

$${β}_{x} = arcsin ( \frac{( n - x + 1 ) * {d}_{wx \text{.1}}}{( n - x + b ) * {d}_{w ( x - 1 ) \text{.2}}} * sin ( {β}_{( x - 1 )} ) )$$

wherein βx denotes the helix angle of the respective gear stage x, n denotes the total number of gear stages, dwx.1 denotes the pitch circle diameter of the pinion in the respective gear stage x and dw(x−1).2 denotes the pitch circle diameter of the stepped wheel in the upstream gear stage (x−1).

The value of b in formula (3) is specified by selecting the factor 1/b of formula (1). That is, the value of b in formula (3) is specified by predetermined fraction 1/b of the axial force FAxM acting on the motor gearwheel that is intended to act on the bearing point of the first gear stage.

### BRIEF DESCRIPTION OF DRAWINGS

Further advantages and characteristics of the invention result from the following description of exemplary embodiments, which are not to be understood in a restrictive sense, and from the drawings, wherein:

FIG. 1 shows a top view onto selected parts of a belt tensioner comprising a spur gearing according to the invention,

FIG. 2 shows the belt tensioner of FIG. 1 with the covers being removed,

FIG. 3 shows a perspective view of the gearwheels involved in the spur gearing of FIG. 1,

FIG. 4 shows a top view onto the gearwheels of FIG. 3,

FIG. 5 shows a sectional view across the belt tensioner of FIG. 1 along the line A-A, and

FIG. 6 shows a schematic sectional view across the gearwheels of FIG. 3.

### DRAWINGS

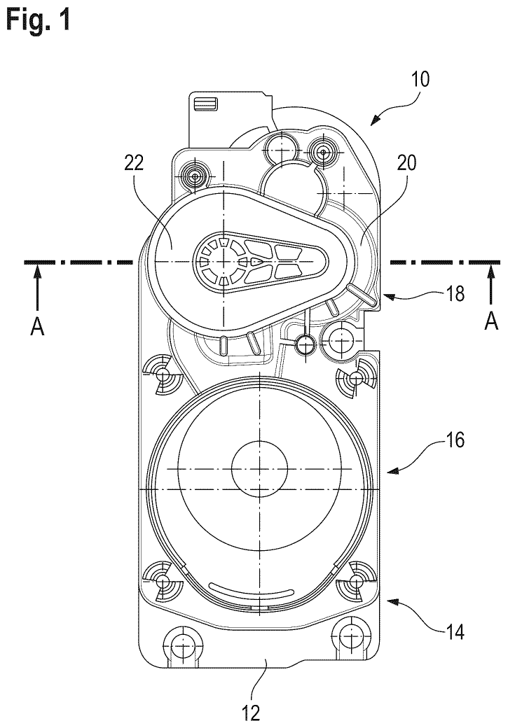

FIG. 1 illustrates a belt tensioner 10 according to the invention which can be used in a seatbelt system, such as in a seatbelt system for vehicle occupants.

The belt tensioner 10 is connected to a frame 12 of a belt retractor 14 in which a belt reel 16 is rotatably supported to wind up webbing (not shown), when the belt retractor 14 is triggered, and to eliminate belt slack.

The belt tensioner 10 has a spur gearing 18 which is accommodated in a housing 20, the housing 20 being closed in turn using a cover 22.

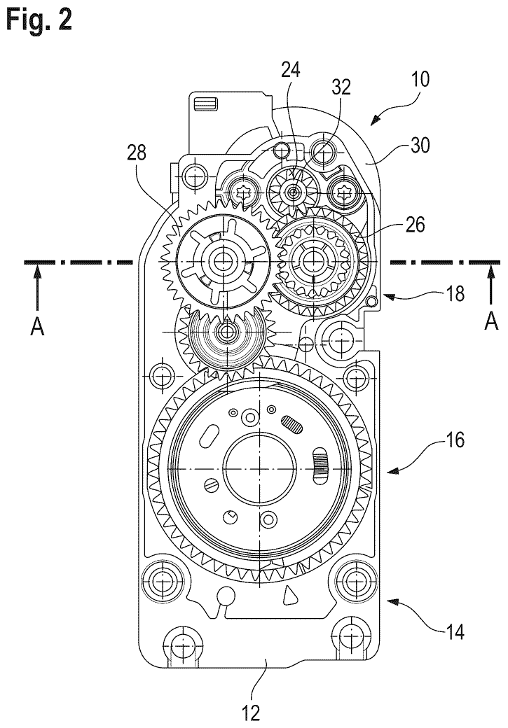

FIG. 2 illustrates the belt tensioner 10 with a partly removed housing 20 and without the cover 22.

It can be seen better from this representation that the spur gearing 18 includes a motor gearwheel 24, a first stepped wheel 26 and a second stepped wheel 28.

The motor gearwheel 24 is driven by means of an electric motor 30 via an output shaft 32 of the electric motor 30, wherein the motor gearwheel 24 can be driven either clockwise or anti-clockwise. The gearing can be coupled with and uncoupled from the belt reel by a clutch system.

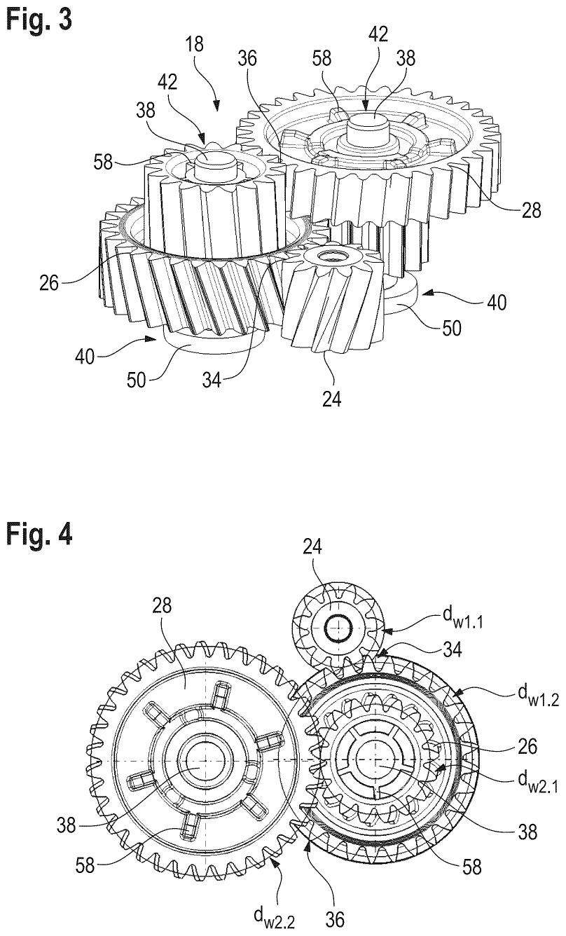

FIG. 3 illustrates the interaction of the motor gearwheel 24, the first stepped wheel 26 and the second stepped wheel 28.

The motor gearwheel 24 forms a first gear stage 34 with the first stepped wheel 26, and the first stepped wheel 26 forms a second gear stage 36 with the second stepped wheel 28.

The first stepped wheel 26 and the second stepped wheel 28 are aligned with each other by a shaft 38 passing through the respective stepped wheel, the shafts 38 of the first stepped wheel 26 and the second stepped wheel 28 extending in parallel to each other.

Each of the shafts 38 has a first axial end 40 and a second axial end 42.

The first axial ends 40 are in the form of collar-shaped projections 50. The shafts 38 are also referred to as bearing pins.

In the shown embodiment, the shafts 38 are made of steel. However, basically all materials which have sufficient mechanical stability and load-bearing capacity are suitable.

It becomes further clear from FIG. 3 that all gearwheels involved in the spur gearing 18, i.e., the motor gearwheel 24, the first stepped wheel 26 and the second stepped wheel 28, feature helical teeth.

FIG. 4 illustrates a top view onto the gearwheels from FIG. 3 in which additionally the pitch circle diameters dw1.1, dw1.2, dw2.1 and dw2.2 of the gearwheels 24, 26 and 28, resp., are plotted, wherein dw1.1 indicates the pitch circle diameter of the motor gearwheel 24 in the first gear stage 34, dw1.2 indicates the pitch circle diameter of the first stepped wheel 26 in the first gear stage 34, dw2.1 indicates the pitch circle diameter of the first stepped wheel 26 in the second gear stage 36 and dw2.2 indicates the pitch circle diameter of the second stepped wheel 28 in the second gear stage 36.

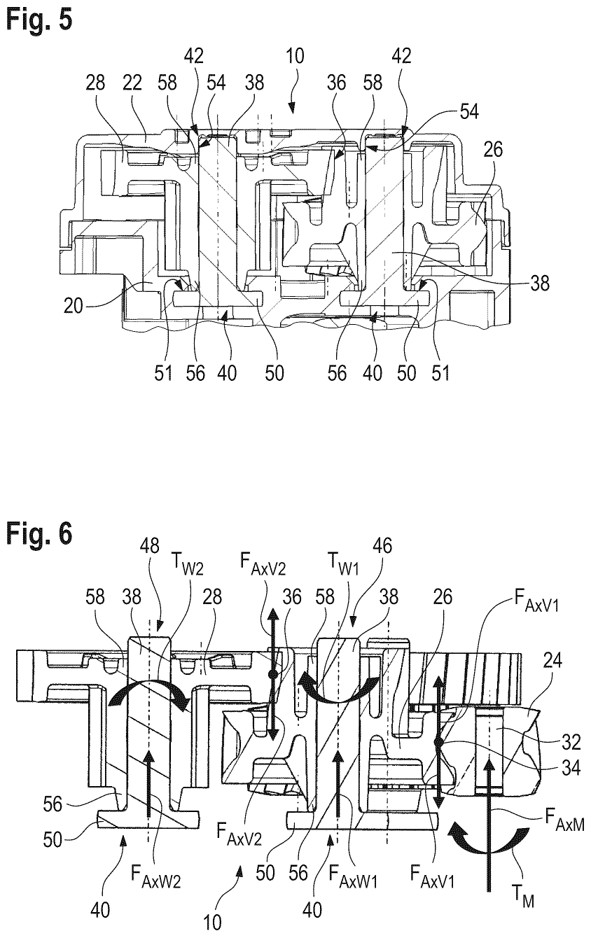

FIG. 5 shows a sectional view across the belt tensioner 10 along the line A-A from FIG. 1.

This representation makes clear that the second axial end 42 of each of the shafts 38 is accommodated and supported in a dedicated mount 54 of the cover 22.

Each of the collar-shaped projections 50 abuts on a bearing point 51 and is connected to the housing 20 by means of a respective injection-molded connection so as to align and fix the shafts 38 in parallel to each other.

The stepped wheels 26 and 28 are supported, on the one hand, on the upper sides of the collar-shaped projections 50 at the first axial end 40 of the dedicated shaft 38 and, on the other hand, on the cover 22 close to the mount 54. This allows a defined startup of the stepped wheels 26 and 28, when the belt tensioner 10 is operated, and ensures a constant distance between the stepped wheels 26 and 28.

Furthermore, it is clear from FIG. 5 that the stepped wheels 26 and 28 have respective contact projections 56 and 58 which contact the collar-shaped projection 50 and, resp., the cover 22. In this way, the contact radius between the respective stepped wheel 26 and 28, respectively, and the collar-shaped projection 50 and the cover 22, respectively, is reduced, thus causing the relative speed and the braking moment to decrease, and allowing the wear of the components involved to be minimized as well as the efficiency of the belt tensioner 10 to be increased.

FIG. 6 illustrates a schematic section view of the gearwheels from FIG. 3 in which the motor gearwheel 24, the first stepped wheel 26 and the second stepped wheel 28 are shown next to each other. In addition, selected physical variables are plotted which are incorporated in the design of the gearwheels.

The motor gearwheel 24 is axially passed through by the output shaft 32 of the electric motor 30 (see FIG. 2) which transmits a motor torque TM, generates an axial force FAxM acting on the motor gearwheel 24 and makes the motor gearwheel 24 rotate.

In the first gear stage 34, specifically in the tooth contact between the motor gearwheel 24 and the first stepped wheel 26, an axial force FAxV1 is generated which transmits the rotation of the motor gearwheel 24 to the first stepped wheel 26.

The first stepped wheel 26 rotates about the associated shaft 38 and in the second gear stage 36, specifically in the tooth contact between the first stepped wheel 26 and the second stepped wheel 28, generates an axial force FAxV2 which in turn transmits the rotation of the first stepped wheel 26 to the second stepped wheel 28.

The rotary motions of the first stepped wheel 26 and the second stepped wheel 28 transmit torques TW1 and TW2, resp., which in turn cause axial forces FAxW1 and FAxW2, resp., at the first axial ends 40 of the shafts 38, i.e., an axial force acting on the respective bearing point.

To ensure a long long-life cycle and smooth running of the spur gearing 18, the helical teeth of the engine gearwheel 24, of the first stepped wheel 26 and the second stepped wheel 28 are configured, according to the invention, so that at least one of the helical teeth, and particularly all of the helical teeth, have a non-integer overlap ratio.

In this way, in the first gear stage 34 and/or the second gear stage 36 a helix angle of less than 10° is reached. With a smaller helix angle, also the magnitude of the axial forces FAxW1 and FAxW2, resp., acting on the bearing points of the shafts 38 decreases, which improves smooth running of the spur gearing 18.

In the following, a preferred method of determining the helix angles of the gearwheels inserted in the spur gearing 18 shall be explained.

The helix angle β1 of the helical teeth of the first gear stage 34 is preferably determined according to the following formula (1):

$${β}_{1} = arcsin ( \frac{{F}_{AxM} * {d}_{w 1.1}}{{T}_{M}} * \frac{1}{b} ) ,$$

wherein FAxM denotes the axial force acting on the motor gearwheel 24, dw1.1 denotes the pitch circle diameter of the motor gearwheel 24 in the first gear stage 34 (cf. FIG. 4), TM denotes the drive torque acting on the motor gearwheel 24 and 1/b denotes a predetermined fraction of the axial force FAxM acting on the motor gearwheel 24 which is intended to act on the bearing point of the first gear stage 34, i.e., on the first axial end 40 of the shaft 38 of the first stepped wheel 26.

The factor 1/b is specifically in the range from 0.4 to 0.8, that is, b is specifically in the range from 1.25 to 2.5.

For example, the factor is 0.5, that is, half of the axial force FAxM acting on the motor gearwheel 24 is intended to act on the bearing point of the shaft 38.

The helix angle β2 of the second gear stage 36 is established, depending on the helix angle β1 established according to formula (1), according to the following formula (2):

$${β}_{2} = arcsin ( \frac{{d}_{w 2.1}}{{d}_{w 1.2}} * \frac{1}{b} * sin ( {β}_{1} ) ) ,$$

wherein dw2.1 denotes the pitch circle diameter of the first stepped wheel 26 in the second gear stage 36 and dw1.2 denotes the pitch circle diameter of the first stepped wheel 26 in the first gear stage 34 (cf. FIG. 4).

If in the spur gearing 18 more than two stepped wheels are used, the helix angle βx is determined in particular depending on the helix angle β(x−1), wherein preferably the helix angle βx of the second or higher gear stage is determined according to the following formula (3):

$${β}_{x} = arcsin ( \frac{( n - x + 1 ) * {d}_{wx \text{.1}}}{( n - x + b ) * {d}_{w ( x - 1 ) \text{.2}}} * sin ( {β}_{( x - 1 )} ) ) ,$$

wherein x denotes the gear stage, n denotes the total number of gear stages, dwx.1 denotes the pitch circle diameter of the pinion in the respective gear stage x and dw(x−1).2 denotes the pitch circle diameter of the stepped wheel in the upstream gear stage (x−1).

In other words, an iterative calculation of the helix angle is performed, allowing a specific distribution of the axial forces acting on the respective bearing points to be realized.

For establishing the helix angle β1, also in this case formula (1) can be used.

According to the invention, in the formulae (1) to (3) the factor b has the same value.

1-10. (canceled)

11. A belt tensioner for a seatbelt system, comprising a spur gearing (18),
wherein the spur gearing (18) comprises at least one motor gearwheel (24) and at least a first stepped wheel (26) and a second stepped wheel (28), the motor gearwheel (24) forming with the first stepped wheel (26) a first gear stage (34) and the first stepped wheel (26) forming with the second stepped wheel (28) a second gear stage (36),
wherein the motor gearwheel (24) as well as each of the stepped wheels (26, 28) include helical teeth and the helix angle of the helical teeth of the second gear stage (36) is determined depending on the helix angle of the first gear stage (34),
and wherein the overlap ratio of at least one helical toothing is not integer.

12. The belt tensioner according to claim 11, wherein the helix angle of at least one gear stage (34, 36) is less than 10°.

13. The belt tensioner according to claim 11, wherein each of the stepped wheels (26, 28) is aligned by means of a shaft (38) which extends axially through the respective stepped wheel (26, 28) and which is supported on a bearing point (51) dedicated to the respective shaft (38) on a housing (20) of the belt tensioner (10).

14. The belt tensioner according to claim 13, wherein with an increasing gear stage (34, 36) a decreasing axial force acts on the bearing points (51) dedicated to the respective stepped wheels (26, 28) or a substantially equal axial force acts on the bearing points (51) dedicated to the respective stepped wheels (26, 28).

15. The belt tensioner according to claim 13, wherein the shaft (38) of at least one stepped wheel (26, 28) is supported at a first axial end (40) of the shaft by means of an injection-molded connection on the housing (20) of the belt tensioner (10).

16. The belt tensioner according to claim 15, wherein the shaft (38) of at least one stepped wheel (26, 28) is supported at a second axial end (42) of the shaft on a cover (22) of the belt tensioner (10).

17. The belt tensioner according to any one of the claim 13, wherein the helix angle of the helical teeth of the first gear stage (34) is determined according to the following formula:
$${β}_{1} = arcsin ( \frac{{F}_{AxM} * {d}_{w 1.1}}{{T}_{M}} * \frac{1}{b} ) ,$$
wherein β₁ denotes the helix angle of the first gear stage (34), F_{AxM} denotes the axial force acting on the motor gearwheel (24), d_{w1.1} denotes the pitch circle diameter of the motor gearwheel (24) in the first gear stage, T_{M} denotes the drive torque acting on the motor gearwheel (24), and 1/b denotes a predetermined fraction of the axial force F_{AxM} acting on the motor gearwheel (24) which is intended to act on the bearing point (51) of the first gear stage (34).

18. The belt tensioner according to claim 17, wherein the helix angle of the helical teeth of the second gear stage (36) is determined according to the following formula:
$${β}_{2} = arcsin ( \frac{{d}_{w 2.1}}{{d}_{w 1.2}} * \frac{1}{b} * sin ( {β}_{1} ) ) ,$$
wherein β₂ denotes the helix angle of the second gear stage (36), d_{w2.1} denotes the pitch circle diameter of the first stepped wheel (26) in the second gear stage (36), and d_{w1.2} denotes the pitch circle diameter of the first stepped wheel (26) in the first gear stage (34).

19. The belt tensioner according to claim 11, wherein the spur gearing (18) comprises more than two stepped wheels (26, 28) and more than two gear stages (34, 36), the helix angle of the helical teeth of the second or higher gear stage being determined depending on the helix angle of the respective upstream gear stage.

20. The belt tensioner according to claim 19, wherein the helix angle of each of the second or a higher gear stage is determined according to the following formula:
$${β}_{x} = arcsin ( \frac{( n - x + 1 ) * {d}_{wx \text{.1}}}{( n - x + b ) * {d}_{w ( x - 1 ) \text{.2}}} * sin ( {β}_{( x - 1 )} ) ) ,$$
wherein βₓ denotes the helix angle of the respective gear stage x, n denotes the total number of the gear stages, d_{wx.1} denotes the pitch circle diameter of the pinion in the respective gear stage x, and d_{w(x-1).2} denotes the pitch circle diameter of the stepped wheel in the upstream gear stage (x−1).
